(19) United States
(12) Patent Application Publication
(10) Pub. No.: US 2012/0110978 A1
(43) Pub. Date: May 10, 2012

(54) Absolute universal engine, one from ground to orbit

(76) Inventor: Marius Angelo Paul, Yorba Linda, CA (US)

(21) Appl. No.: 13/134,696

(22) Filed: Jun. 14, 2011

Related U.S. Application Data
(60) Provisional application No. 61/456,508, filed on Nov. 8, 2010.

(51) Int. Cl. F02K 9/00; F02C 3/00; F03H 99/00; F02K 3/00

(52) U.S. Cl. 60/203.1

(57) ABSTRACT

This invention relates to absolute universal engine for aviation, from ground to orbit and space, by total integration of all modes of operation, turbo fan subsonic, turbo jets supersonic, turbo air ram rockets, and turbo space rockets, <<<One Engine From Ground to Orbit>>>

This invention relates to absolute one universal engine for aviation, from ground to orbit and space, by total integration of all modes of operation, turbo fan subsonic, turbo jets supersonic, turbo air ram rockets, and turbo space rockets, <<<One Engine from Ground to Orbit>>

Conventional aviation engines, are build specific for each mode of operation, from ground in air and for space, for each speeds, turbo fans subsonic, turbo jet supersonic air breathing ultrasonic ram jets, and finally orbit space rockets.

These specifics concepts and diversification, are reflected also in the specific aviation, and space distinct flying vehicles, and concepts.

A conventional typical high by pass turbofan, build for 5/1-10/1 bypass ratio, is using for the core engine only 1/5-1/10 the air entering for combustion from the frontal area of the fan. The core combustion engine is using only 1/4 the air, with high usually 60/1 air fuel ratio, for reducing the combustion temperature, from stoichiometric level to acceptable temperature for the gas turbine operation.

The final air breathing can be 1/5×1/4=1/20, or 10/1×1/4=1/40 real combustion capacity from total area of the engine only 5%-2.5%.

The main limitation of existing top actual gas turbines are:

1. Limited temperature acceptable for turbine inlet temperature, conducting to high air fuel ratio, and limited low power density, and low trust to weight ratios, big complexity, and high price for all engines.

2. Limited high speed rotation of high temperature gas turbines components, like disks of turbines.

3. Limited pressure ratios, conducting to low efficiency.

4. High exhaust temperature, including for after burning, conducting to high infrared signature.

### BRIEF DESCRIPTION OF THE INVENTION

Our absolute universal engine of this invention, is capable to use at maximum power all the air at stoichiometric combustion producing a total 20-40 times biggest maximum absolute power over any and all conventional, air breathing aviation engine, capable to reach 40 times more power and trust to weight ratios, to 200/1, using the same size air intake. For space operation using pure oxygen the power and trust to weight ration can be the unimaginable 5 times maximum absolute 1000/1.

The fundamental result of the concept technology of this invention is the maximum absolute thermodynamic efficiency cycle Paul-Carnot, and the <<<one engine from earth to the universal space>>>, at maximum absolute thermal efficiency.

Unlimited maximum altitude atmospheric flight with over Mach 5, turbo air breathing turbo air-rocket, and unlimited 10-20 MACH, to orbit, and satellite mode, turbo space cryogenic Paul-Carnot cycle.

By comparison the actual 150,000 lb trust at high by pass ratio 5/1-10/1 can reach the level of 3,000,000-6,000,000 lb, capable to replace the shuttle solid fuel rocket engines.

The same engine for space operation using pure oxygen and hydrogen, the trust can be amplified 5 times more to 15,000,000-30,000,000 lb., total maximum absolute, and by using nuclear reactors cooled by the compressed air, will result an eternal capacity for travel without any fossil fuel consumption. The same engine is provided with at least three vectorially jets, for vertical take off and landing, creating <<<vtol universal aviation and space engine>>> for connecting without air ports, all the locations with all locations on this planet, including space unlimited interplanetary flights.

The same universal nuclear mobility vehicle vtol, capable to stay in fixed position indefinitely at ultra high altitude forever, over any potential hostile launching intercontinental missile, against the human civilization, can instantly suppress, and destroy, all enemy of the human civilization, from the first minute of operation, this can be the supreme protection of the entire humanity.

The basic core engine pressure ratio for combustion, at stoichiometric level is capable to achieve 200/1-300/1, compression, combustion, expansion ratios, with potential zero infrared signature, included in a total adiabatic structure, maximum absolute thermal efficiency over 80%, with no after burning at super and ultra sonic sustainable and continuous speed.

This invention is creating an universal fuel capability, including a unique engine with nuclear alternative capability, for unlimited available energy, time and range, zero emission, and global unlimited range, avoiding refuel in air, is a fundamental revolution for eternal aviation and space starting now and forever.

The direct launching satellites, including global unlimited range, for unlimited size of vehicles, for a new generation of totally recoverable of space shuttle, without losing solid rocket busters, will make commercial satellites affordable, and space flight commercially possible. The immense possibility to re-engine of all aviation military and commercial with global range maximum absolute efficiency, with low cost engines, and minimum absolute fuel consumption, can revolutionize the world economy for universal aero-space transportation. The maximum absolute unique structural strength characteristic is the central gas turbine cool core, of all the compressor and gas turbine disks components, conserving the maximum materials strength, raising the maximum speed of rotation, and supreme security for flying.

### BRIEF DESCRIPTION OF PREFERRED EMBODIMENT OF THE INVENTION BY THE FOLLOWING FIGURES

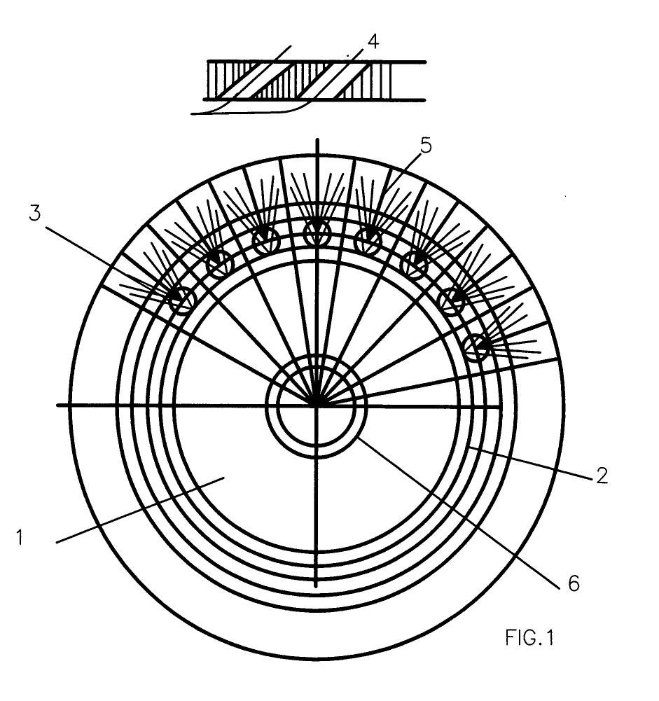

FIG. 1 The <<<ONE INTEGRATED>>> turbo fan, turbo compressor, and concentric peripheral gas turbine rotor.

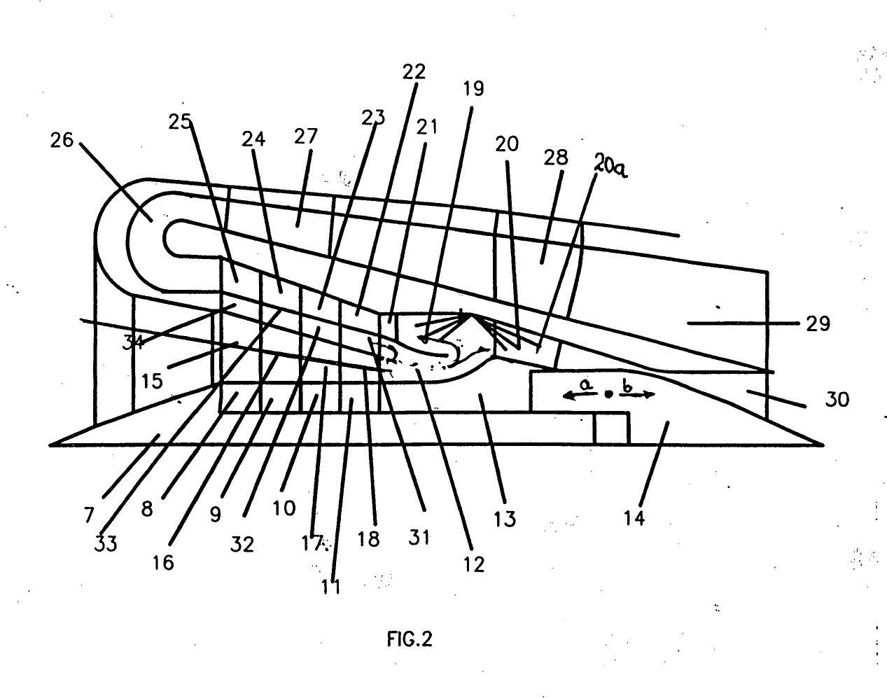

FIG. 2, The Universal Counter Turbo Jet Air Rocket.

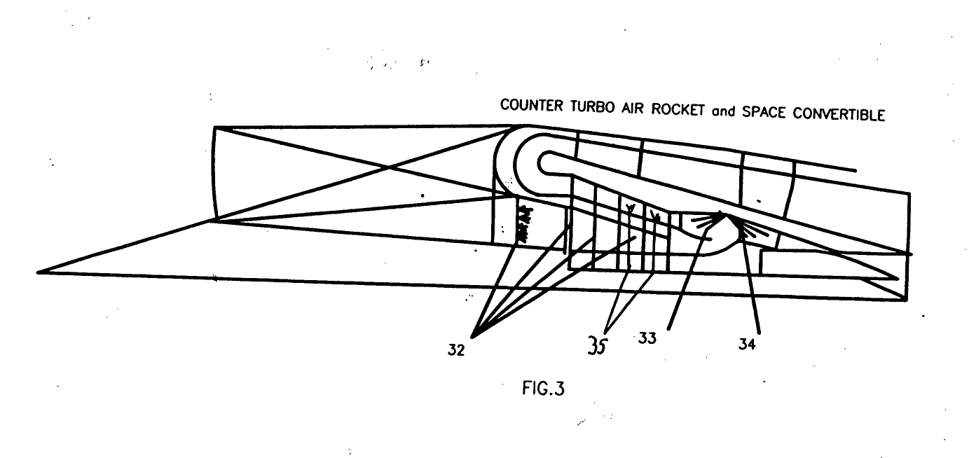

FIG. 3, The Universal Counter Turbo Air and Space Engine

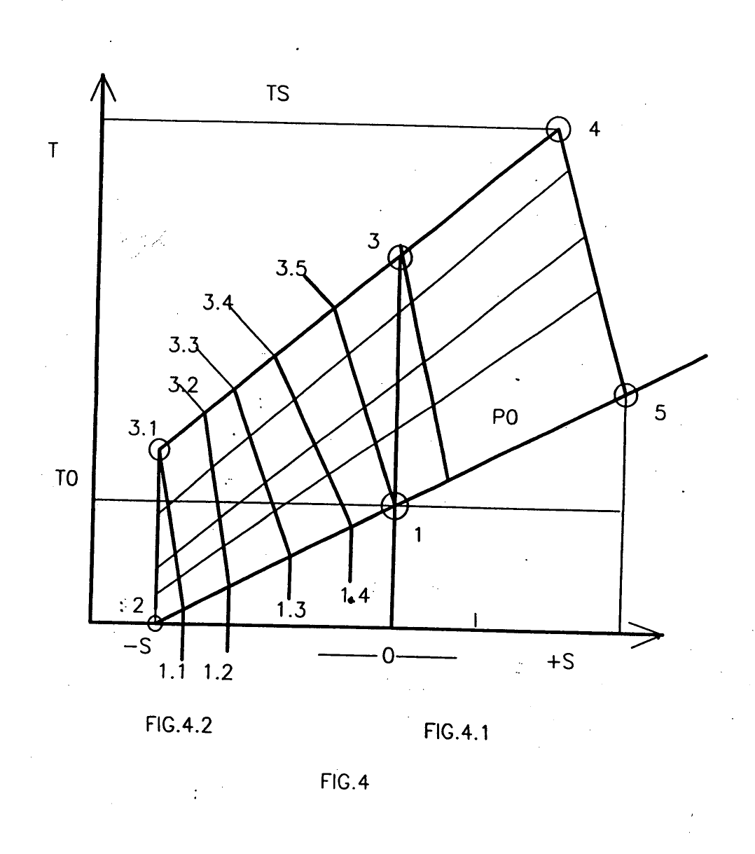

FIG. 4, The Universal Paul-Carnot Thermal Cycle, for rocket convertible engine

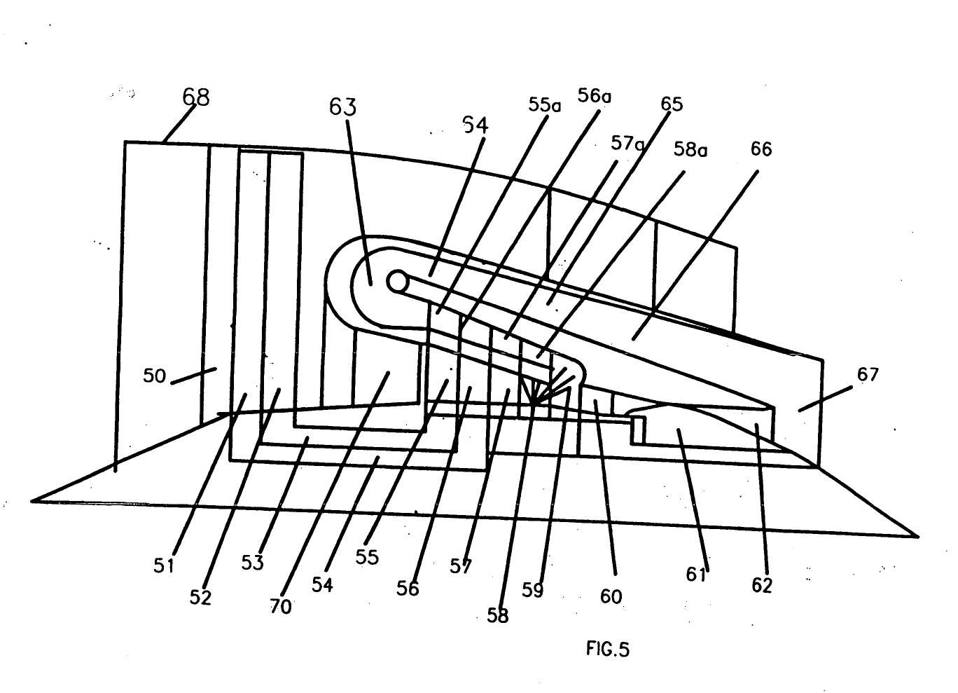

FIG. 5, The Turbo Counter Fan, Counter Turbojet, Air Rocket

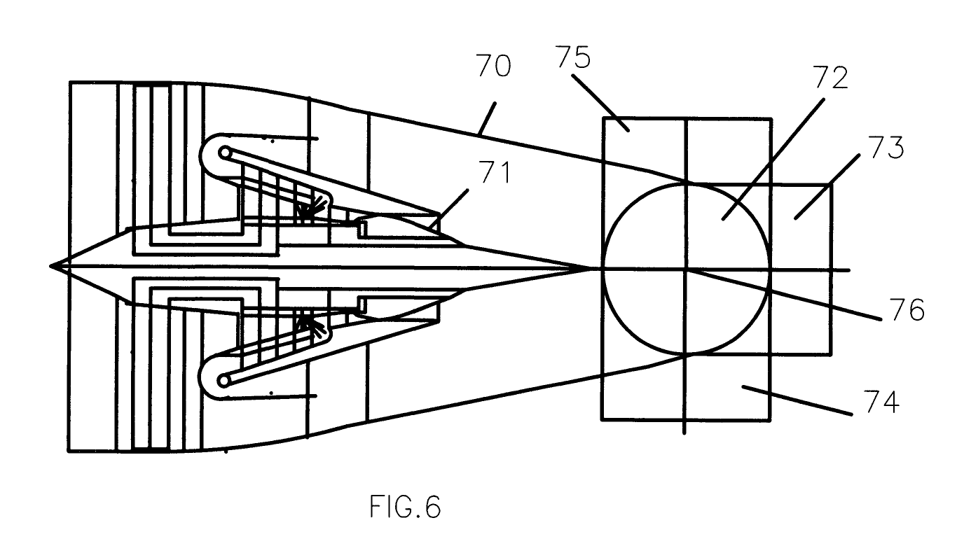

FIG. 6, The Turbo Counter Fan Adiabatic Engine

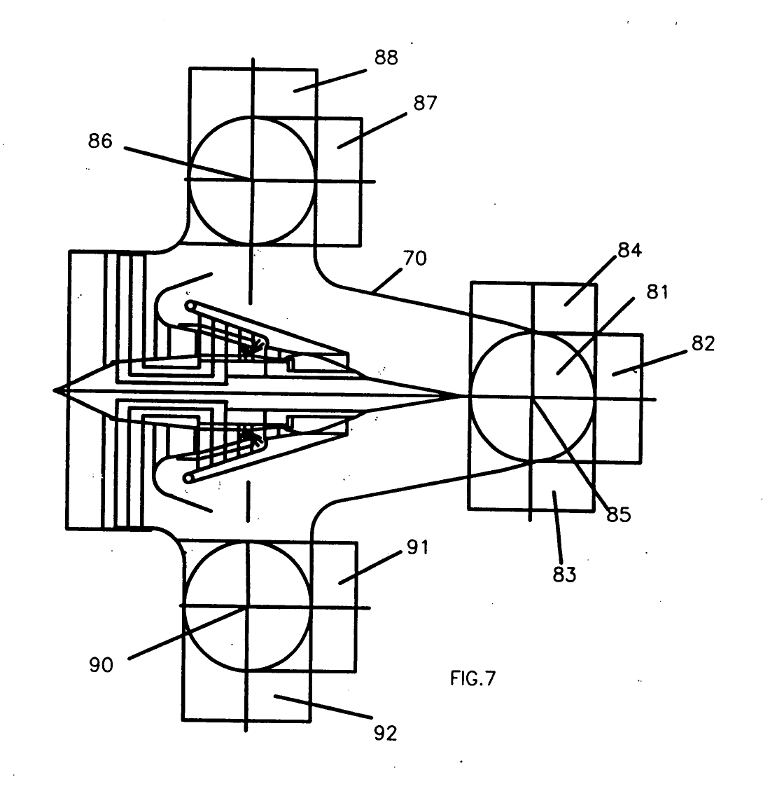

FIG. 7, The Universal Mobility VTOL Adiabatic Engine System

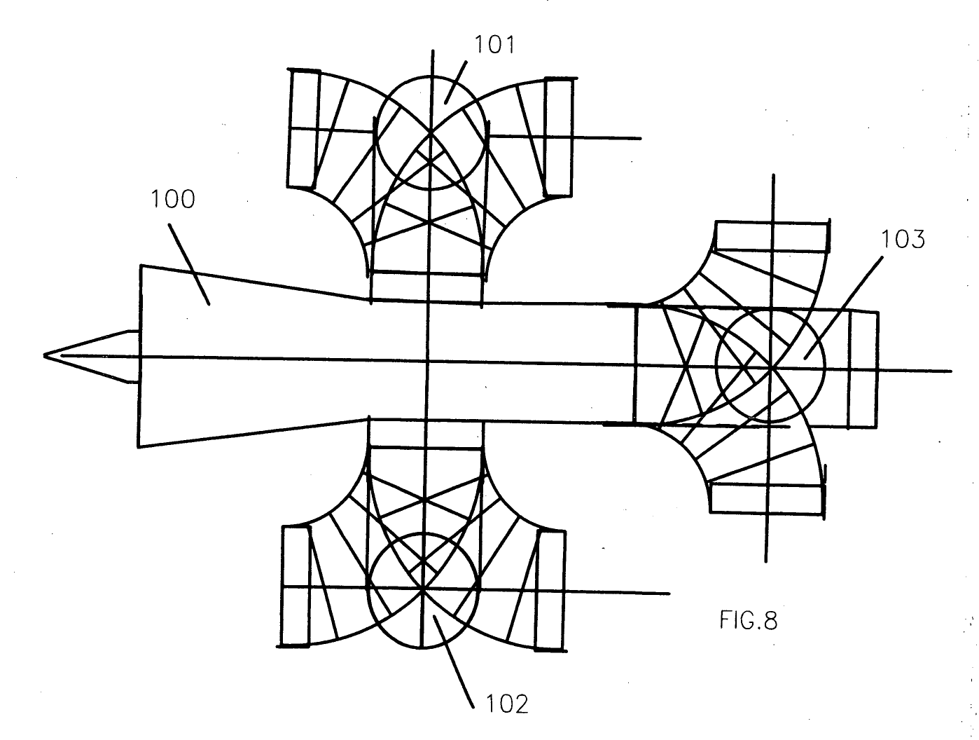

FIG. 8, The Universal Total Mobility-Stability System.

The FIG. 1, is depicted the <<<ONE INTEGRATED>>> Turbo fan, Turbo Compressor, Concentric Peripheral Gas Turbine, which is composed from a central fan disk rotor 1, surrounded by a ducted crown 2, of a concentric gas turbine air cooling roots 3, provided by self axial pumping air cooling blades roots 4, conducting the cooling air inside the gas turbine blades 5, from which an air film and injected fuel homogenous mixture cooling fluid generated inside the turbine blades, will emerge outside surface of gas turbine blades through micro holes, are producing an air transpiration external film over the surface of the blades, with intensive internal and external cooling, and inter stage isothermal combustion.

The biggest physical mass of the central core of the fan compressor, is the maximum sink heat absorber cooling of the concentric crown of gas turbine blades, by conducting, convection, and heat recovery transferred to the central air flow energizing the propulsion.

This invention is creating a unique new generation of gas turbines with cooled central core the maximum secure flying aviation in the world.

The unique concentration in <<<ONE, or 2, 3, 4 disks>>> of all multiple functions of fan, compressors, and gas turbine, is the base for maximum simplification, eliminating the biggest complexity and huge cost of <<<thousand components>>> of actual gas turbines, having in front fans, followed by multiple stages of compressors, and multiple stages of turbines wheels at the end of the entire gas turbine assemble, our invention is a major maximum technology revolution, and massive cost reduction.

The complete rotor is free centered on the tubular hub bearing 6.

The FIG. 2, is depicted the Universal Counter Turbo Jet Air Rocket, composed from a central body 7, forming the axial hub support of all the engine, on which are arranged successively the turbo counter rotating free fan rotors, 8,9,10,11, described in the FIG. 1, arranged in a successive stages of axial counter rotating free rotors for compressors, 15,16, 17,18, supplying the compressed air in the combustion chamber 12, framed by the combustion body 13.

The fuel injectors 19 is producing the combusted gases in the combustion chamber 12 conducting the gases in the nozzles 21, and in the counter rotating turbines 22, 23, 24, 25, and through the return exit collector jet channel 26,27, 28 are ejected by the final nozzles 29 to produce the final propulsion combined jet 30.

The fuel injectors 20 is supplying the variable geometry rocket combustion chamber 20a with variable geometry rocket controller 14 which can be adjusted axially in (a or b) direction for controlling the rocket final free jet.

From the combustion chamber 12, and the rocket combustion chamber 20a, the variable geometry rocket control 14, is creating a coaxial, variable rocket jet expansion in parallel with the gas turbine jet reaction.

The combustion chamber 12, working with jet liquid fuels, can be alternatively, and optionally replaced by a nuclear reactor, supplying nuclear energy to the cooling compressed air, heated and directed in the counter rotating gas turbines and the rocket chamber 20a, and the variable geometry 14 rocket expansion in parallel with the gas turbine also nuclear gas turbine jet reaction.

The nuclear optional alternative, is a supreme major opportunity, to extend the application of the this fundamental absolute unique invention to the level of eternal and indefinitely universal unlimited aviation and space transportation systems in the world forever.

At the moment the counter rotary turbines are reaching the speed limit, and more air is available for combustion, including from higher speed entering in the engine, the second rocket variable exit, is using all the air for complete combustion until stoichiometric maximum level, unlimited with full energetic capability.

A part of the compressed air is conducted through the air turbine blades roots 31, 32,33, 34, for cooling the gas turbine blades, and forming a barrier, between compressed air flow and gas turbines gas flow.

The one massive body of the free turbo fan, associated with peripheral gas turbine blades, is a direct heat absorber, and regenerative cooler by massive structure of the counter rotating central fan-compressors, creating the unique new generation of revolutionary gas turbine with coaled central core turbines.

The fundamental unique capability, of total elimination of after burner, with lowest efficiency, maximum high fuel consumption, high infrared signature, and very short capability operation at supersonic speed, this unique invention is producing a new generation of sustainable supersonic, and ultra sonic air breathing aviation, to the highest altitude of atmosphere.

The air rocket complete and direct free expansion, from the maximum pressure 200-300 ration, to the external pressure, is generating maximum efficiency, and minimum exhaust temperature, and minimum to zero infrared signature.

The total capability to use 100% stoichiometric full combustion of the total air entering in the frontal area of the engine, at constant pressure ratio, at all regimes of flight, controlled by the variable geometry of the rocket jet, is the fundamental unique characteristic and supreme quality, of this invention.

The maximum absolute power, and trust to weight ratio, at maximum sustainable supersonic and ultrasonic speed, from ground to the end of the space, at maximum absolute Paul-Carnot thermal efficiency cycle, by this invention, the thermodynamic history is at the maximum end of the evolution.

In the FIG. 3, is depicted the Universal Counter Turbo Air and Space

<<<One Turbo Rocket Convertible Engine>>>, composed from all the components described in the FIG. 2, with a supplementary variable geometry control intake 31, and the liquid oxygen injectors 32, and all the liquid fuels injectors, including hydrogen injectors 33, and 34, including inter stage liquid fuel injection, 35, for isothermal combustion and expansion, and for internal liquid fuel cooling gas turbine blades, and final vaporized external film cooling of gas turbine blades.

The same invention, alternative option can replace the combustion chamber by an equivalent nuclear reactor, making a supreme absolute propulsion one engine from ground to orbit.

For naval alternative aviation the nuclear alternative of this invention is giving to the navy the supreme and universal power for universal world missions, eternally and indefinitely.

At very high supersonic speed, the variable geometry intake control 31, is adjusting the air flow capacity of the engine, and at the highest altitude, were the reduced oxygen/air density, the liquid oxygen injectors lox, 32 is providing the corresponding evaporated gasified oxygen, creating a very low temperature general environment, with total cooled internal engine body, and a very favorable Carnot isothermal compression, which in final stage is associated with an isothermal interstage combustion expansion stoichiometric, and adiabatic final expansion, perfect Paul-Carnot cycle of maximum absolute efficiency.

The maximum absolute power density, combined with maximum absolute efficiency, is the maximum absolute revolution <<<ONE ENGINE>>> in the air and in the unlimited universal interplanetary propulsion.

The total elimination of the infra red signature of all aviation military and commercial, by this invention, is generating the absolute protection of aviation against terroristic and hostile actions of anti aircraft rockets of any kind.

In the FIG. 4, is depicted the fundamental thermodynamic base of this invention, and unique revolutionary absolute thermal efficiency, and presented in the T-S diagram of two region of operation:

FIG. 4.1 IS the Braiton air cycle, with maximum pressure ratio, in the range of 300-400/1 pressure ratio, which is the condition for highest thermal efficiency, over 80% for this invention air breathing gas turbines, and universal jet propulsion, highest altitude atmospheric flight, and this invention new category of universal engines in the region of T-S (+) positive entropy limited thermal efficiency.

<<<The Turbo air rockets combined integrated cycle in One Engine>>> starting Any regime indicated from point (1), atmospheric condition, T-Po ambient, to maximum compression pressure P3, OF 300-400/1 pressure ratio, constant pressure combustion until maximum temperature (4), expansion from (4) to (5) thermodynamic

FIG. 4.2, is depicting the Paul-Carnot cycle in the T-S (−) negative entropy region, which can run including in all the air and space, unlimited flight, including cryogenic operation, with total maximum absolute efficiency, from ground to unlimited space orbital and interplanetary travel.

The fundamentally potential flight in cryogenic flight mode with negative entropy (−), is eliminating totally the infrared signature in a total stealth regime.

Starting from atmospheric condition, the liquid oxygen injection in the frontal intake of the engine (1) described in the FIG. 3, the bottom temperature (2.0), of the evaporation of the liquid oxygen (−183 C; −297.4 F; −90 , 15 K) is starting the adiabatic compression from (2), to (3.1), starting constant pressure combustion from (2) to (3.1); (3.2); (3.3); (3.4; (3.5); (3) successive part loads operation, and expansions to points (1.1); (1.2); (1.3); (1.4), ending combustion until maximum point (3), coincident whit the vertical adiabatic expansion, back to the starting point (1).

All exhaust cryogenic points 1.1 . . . 1.4 are under original starting points 1, using maximum absolute the cycle thermal energy, to maximum absolute efficiency, and zero infrared signature.

The use of liquid hydrogen for cooling the nuclear reactor is producing the maximum absolute heat adsorbing capacity and the maximum efficiency Paul-Carnot nuclear cycle.

These universal thermodynamic absolute efficient cycles and operations are qualifying this invention, and these new engines, to the top absolute revolution of the thermodynamic.

In the FIG. 5, is depicted the Turbo Counter Fan, Counter Turbo Jet, and the Turbo air Rocket, resulting the total integrated of all modes of operation, of the super by-pass like 10/1 engine configuration, extension of the basic universal engine concept described in the FIG. 2.

The additional frontal counter rotating fans, is creating a new class of complete total general integration of all types of aviation configurations.

In the regime of turbo rocket jet, and gas turbine combined jet operation, the high speed produced by all combined modes, is transforming the counter rotating fans in front <<<air activated turbines>>>.

The basic composition of this configuration is using the same core engine of FIG. 2, on which is attached the two counter rotating fans 51 and 52, connected by the concentric shafts, 53, 54, with the first counter rotating turbo compressor-gas turbine disks 55, 56, followed the next counter rotating turbo compressors gas turbine disks 57, 58.

The combustion chamber 59, and connection 60, is activating the variable geometry rocket controller 61, creating the final air rocket jet 62.

The turbo jets driving the peripheral turbine blades, 55a; 56a; 57a; 58a, starting from combustion chamber 59, to exit collectot jet 63, 64, 65, 66, and combined jet 67.

Entire engine is included in the nacelle 68, provided with struts 69.

In the FIG. 6, is depicted the Universal Mobility (vtol), composed from the same engine configuration described in the FIG. 5, included in the adiabatic envelope 70, in which all the gas turbine jets, air rocket jets, are mixed and combined in an homogenous jet 71, and collected and vectorized in the multiple orientable vectorial jets 72, 73, 74, 75,76.

The process of mixing and homogenization of air and all exhaust gases are eliminating all the infrared signature, and is creating a totally combined universal integrated cycle, with multiple propulsion vectorial jets for ultra mobility capability.

In the FIG. 7, is depicted the Universal Total Mobility and Stability Engine, based on concept engine described in the FIG. 6, integrated in a triple multi vectorial cross adiabatic configuration, which is creating maximum, total mobility and optional stability, and 5 axis universal capability, with maximum efficiency, with cumulative total integration. The triple cross vectorial arms 81;82; 83; 84; 85;86; 87; 88; 90; 91;92, for distribution the total vectorial jets, is introducing the total and absolute mobility and stability.

The triple multi directional vectorial jets, are totally free from infrared signature, and universal stealth capability.

This totally integrated multi gas turbines, air rockets jets, can be the ideal base for creating the universal aviation, without air ports, connecting the entire globe of all locations, with all locations by the top revolution in the history of the humanity transportation.

In the FIG. 8, is depicted the general universal mobility and stability engine configuration, which is including in an integrated adiabatic general thermal .of all engines configurations, including nuclear alternative, described in all previous FIGS. 1 . . . 7, and in any more potentional variation, with unlimited alternatives, for many reasons of absolute mobility and stability operation, from ground to orbit.

Eliminating the lowest level of efficiency, from ground to orbit helicopters, creating the capability for unlimited use of all vectorial jets, for all military and commercial missions, is offering by this unique invention, a global universal range capability.

This invention is based on the central engine described in the FIG. 1 . . . 7, and other potential similar alternatives, provided with cross vectorial arms 101, 102. 103, capable to be an unlimited general concept systems for universal mobility and stability for any air and space vehicles

What is claimed:

1. The invention is the creation of the absolute, one universal engine, based of one fundamental combined central free turbo compressor rotor, and a concentric, crown of turbo gas turbine, peripheral power generator forming the unique basic rotary unified component, of the entire engine, capable to form the base for a new universal class of engines for aviation, and space, for total and universal unlimited operation from ground to unlimited space, by total integration of all modes and capability of operation, turbofan subsonic, turbo jets supersonic, turbo ram jets air rockets, for ultra supersonic, and turbo rocket for space, by total maximum absolute power capacity, with central total cooled core engine body, for using all the air/oxygen entering in the engine for combustion at stoichiometric level, at maximum absolute compression, produced by a group of free counter rotating central compressors, a central one combustion chamber, and/or a nuclear reactor, supplying heated or combusted gases to the group of free counter rotating concentric gas turbines, and to the final free rocket combustion/nuclear chamber, with variable geometry jet final combined propulsion, by the maximum thermodynamic absolute efficiency Paul-Carnot cycle, operating in air breathing, positive entropy environment, and in cryogenic negative entropy region for air and space operation, with unlimited sustainability for supersonic, ultrasonic and unlimited speed in space, with total absolute mobility and stability produced by tree multi axis vectorial jets, produced by the adiabatic general structure.

2. The fundamental core of this invention, from claim one, is the unique turbo rotor one body, of central compressor rotor, surrounded by a concentric crown of peripheral gas turbine blades, forming a united body of turbo rotor compressor and gas turbine disk, integrating all the feature and characteristics by the united free rotary compressor and gas turbine, which can be associated in multiple stages of central counter rotating compressors and multi stages of counter rotating gas turbines, producing power in the same body which is used directly the power by the fans and compressor wheels, without shafts or any transmissions, forming the central cooled body of any multiple stages of free counter rotating compressors, and free counter rotating concentric gas turbines, cooled by the one massive body of the central fan-compressor, by conduction and convection the heat from the gas turbine crown to the wheels of the concentric fan compressor, in a process of recovery and of transfer the heat to the air and to the propulsion fluid, transforming any cooling loses in totally recovered energy for propulsion, in association with internal gas turbine blades cooling by air and fuel injection, forming intensive homogenous mixture of air and injected fuel, which by transpiration, will produce an external film of air and vaporized fuel, which is generating interstage isothermal combustion and expansion, characteristic for Paul-Carnot maximum efficiency thermodynamic cycle.

3. The invention of the Universal Convertible Counter Turbo Jet Air and Space Engine, from claim one, and two, which is using the same core engine, with additional variable geometry intake for air, or liquid vaporized oxygen, with central air and cryogenic cooled total body of the engine including the free counter rotating isothermal compressor stages, and the free counter rotating concentric gas turbines stages, with combustion total stoichiometric and isothermal inter stages gas turbine combustion, with combined air and internal injected fuel for cooling the gas turbine blades with internal and external vaporized liquid combined air and film cooling, and isothermal combustion and expansion in addition of the central combustion/nuclear chamber supplying with combusted gases the concentric peripheral gas turbine stages and central stoichiometric combustion/nuclear reactor rocket chamber, with variable geometry free rocket jet, by combustion of any universal liquid fuels or cryogenic liquid hydrogen, creating the maximum absolute efficiency Paul-Carnot cycle, with zero infrared emission of minimum absolute even cryogenic exhaust stealth gases, for universal air and space unlimited flight.

4. The fundamental thermodynamic Paul-Carnot cycle, is the base for the claims one and two, and universal air and space unlimited operation in all environment, modes and capabilities, for Turbo Fan Subsonic, Turbo Jet Supersonic air and in space, Turbo Ram-Rocket Convertible Engine for air and space, and for any alternative and general applications of this invention, acting in all the positive and negative entropic regions, for universal application in all the thermodynamic operation, with maximum absolute thermodynamic efficiency.

5. The invention of Turbo Counter Fan, Counter Turbo Jet, and Turbo Air Rocket, from claims one, two and three, is the total integration in one combined universal engine, of all capabilities and flying for aviation, including a new class of engines with air activated fan turbines, by reversing effect of high speed created by the air rocket maximum jet and high speed, extending the unlimited power density, by general and total combustion at stoichiometric maximum level of entire air and oxygen entering in the engine, to unlimited power and trust to weight ratio, and bypass ratios, and universal integrated combined cycle, including nuclear alternative, with a total homogenous mixed energy of air and combustion gases, resulted from the turbo fan, turbo jet, and turbo rocket, total universally energy combined thermal cycle, producing maximum absolute power density, trust and efficiency of Paul-Carnot thermodynamic cycle.

7. The invention of Universal Mobility (vtol), vertical take of and landing of claim one, and five, is using the same basic engines, from claim one, included in an adiabatic envelope in which all the air and combusted gases are mixed and forming a homogenous propulsion fluid, collected and vectorized by multiple vectorial jets, with low temperature and reduced to zero the infrared signature, combined with ultra mobility capability.

8. The invention of Universal Total Mobility and Stability Engine, from claim one and six, is forming a triple integrated, multi vectorial cross adiabatic configuration, which is creating maximum absolute, total mobility and optional stability, with 5 axis universal capability, with maximum efficiency Paul-Carnot cycle, with cumulative integration of all capability for universal aviation, and universal global transportability, from any place to any place without air ports on this planet and space.

9. The invention of Universal General Mobility, with all engines configurations from claim one to seven is opening a new era of absolute and universal aviation and space operation, with maximum absolute efficiency Paul-Carnot cycle, with a new class of universal vehicles, replacing and re-engining all helicopters and low efficient engines of actual military and commercial aviation, for eternal cross general mobility universal aviation and space. 6

10. The invention of Universal and Global Aviation, and Space, of claim one, and the replacement of all military and commercial engines of any size and application, for any mission, under general protection for elimination of infrared signature, is a fundamental major national security reasons for national priority urgent actions.

11. The invention of Absolute Universal Engine, one from Ground to Orbit, of claim one, is creating a fundamental eternal solution for a new universal economic revolution, by replacing all existing engine with the new maximum absolute efficient engines offered by our ultra efficient minimum fuel consumption, at the moment and opportunity for routine replacement of all actual old low efficient existing engines, guilty today for bankruptcy, of all aviation, produced by enormous prices of aviation petrol, without any hope for future recovery.

12. The invention of Absolute Universal Engine, One from Ground to Orbit, from claim one, is the absolute and fundamental unique solution offered by this and specific unique creation of this invention, for producing a new era of universal aviation and space travel, without of solid rocket busters, affordable and ready to launch any aviation and space vehicles, of any size and for any missions, with minimum cost and maximum efficiency, based on our Paul-Carnot Cycle, with universal capability now and for ever, with zero infrared signature, for absolute protection from any and all terrorist actions, and the supreme protection, is the result of using the combustion chamber like a nuclear reactor, in which the compressed air is the cooler fluid, with unlimited propulsion capacity forever.
